(19) United States
(12) Patent Application Publication
(10) Pub. No.: US 2023/0072561 A1
(43) Pub. Date: Mar. 9, 2023

(54) A PORTABLE APPARATUS, METHOD, AND SYSTEM OF GOLF CLUB SWING MOTION TRACKING AND ANALYSIS

(71) Applicant: Rayem Inc., Tucson, AZ (US)

(72) Inventor: John Yoon, Tucson, AZ (US)

(73) Assignee: Rayem Inc., Tucson, AZ (US)

(21) Appl. No.: 17/797,921

(22) PCT Filed: Feb. 3, 2021
(86) PCT No.: PCT/US2021/016452

§ 371 Date: Aug. 5, 2022

Related U.S. Application Data
(60) Provisional application No. 62/970,196, filed on Feb. 5, 2020.

(51) Int. Cl. A63B 69/36; A63B 24/00

(52) U.S. Cl. CPC A63B 69/3608; A63B 24/0003; A63B 69/3676; A63B 2220/12; A63B 2220/30; A63B 2220/806; A63B 2225/20; A63B 2225/50

(57) ABSTRACT

An apparatus, method, and system for measuring a golf club swing motion, especially a golf putting stroke, from the overhead view and enabling to provide in-situ athletic training and instruction along with analysis of the putting stroke by using augmented reality superimposed on the image of the actual golf club. The system comprises a portable apparatus, mobile device application interface, image processing algorithms and network servers. The portable apparatus includes a mini-camera and communication modules for capturing the video image of a putting stroke and transmitting the image via wireless, Wi-Fi, Hotspot, or Bluetooth to a designated electronic display device such as a tablet, mobile phone, or laptop. The portable apparatus is fixed to a fastening clip which fits easily onto a golf cap to provide the overhead view of the putting stroke and record the image from an actual golf course.

### FIELD OF INVENTION

The present disclosure relates to a portable apparatus, method, and a system for providing an overhead view image of a golf swing motion, especially golf putting motion, and golf ball movement on a field, where such motions are captured by a mini-camera mounted on a golf hat in a manner that the viewing angle can be adjusted, and the images are transferred to a designated electronic display device via wireless methods for augmented analysis of the golf swing motion by image processing methods for efficient and in-situ training or instruction.

### BACKGROUND

In a round of golf, about 43% of the golf shots consist of putts. Therefore, putting performance is considered the most important element in order to minimize a player’s golf score. In order to provide putting performance feedback, advanced sensors have been used to measure the characteristics of the putting stroke in complicated and expensive systems where the sensors are attached to the body of the golfer or interfere with the golfer’s movement. Such golf motion analysis systems primarily use ultrasonic methods, accelerometers, and gyroscopes. They measure motion-based characteristics. However, these attached sensors can adversely affect the putting stroke.

In other embodiments, systems of video recording and computer motion analysis have been developed for the purpose of providing effective instructions to students for improving their golf putting strokes. The image-based information is greatly effective to improve the golfer’s learning experiences. Therefore, the image captured by the camera has been favored by golfers and instructors for training or instructing a golfer to improve their putting strokes.

Various patents and current products for teaching and analyzing putting strokes are as follows.

U.S. Pat. 6,565,448 B2 and 7,283,647 B2 disclose apparatus, methods, and systems that involve video camera recording that are connected to computers via cables in an indoor environment. The analysis of the putting strokes is displayed by the computer processing environment.

Science & Motion Putt Studio, provides an analysis and training system established in an indoor facility. This is an extremely expensive training system.

OptiShot Pure Golf Putting Simulator is a device containing a high-speed camera that is placed on the ground and faced toward the putter typically in front of a golfer. The putting stroke motion is measured and presented with analysis data in simulated images on a laptop that is connected to the device with a USB cable.

Blast Motion Golf Sensor comprises a sensor attached to the butt of the golf club grip in order to obtain data associated with a putting stroke motion. The analysis is presented in computer graphic images by using mobile apps or cloud-based computer systems.

BioMech Golf Putting Sensor comprises a sensor attached to the shaft of a golf putter in order to gather data associated with a putting stroke motion. The analysis is presented in simulated graphic images by using mobile apps or cloud-based computer systems.

Generally speaking, these existing putting stroke analysis devices are undesirable and fail to provide sufficient information to the golfer. Firstly, several of these systems are prohibitively expensive for golfers to afford. In some instances, an expensive indoor facility setup is required. Moreover, the indoor setup limits a golfer’s training experiences to a simulation environment instead of a real world environment.

Next, it is undesirable to attach any external device(s) to a putter in order to measure the characteristics of the putting stroke motion. Such attachments can adversely affect the golfer’s training because the attached device adds weight, changes the ‘feel’ of the stroke, changes the momentum of the strike, changes the line of sight from a top-down view when a golfer makes a putting stroke motion at a ball, etc. Moreover, according to most official golf organization rules, a golfer is not allowed to have the device attached to their putter during a golf match. Therefore, a golfer feels differently from their training or practicing when they perform for official record.

In other disadvantages, systems measuring motion-based parameters (e.g. using accelerometers and/or gyroscopes) often display their analysis results using computer simulated images which make it difficult for a golfer to relate the analysis presentation to their view of the real world when they perform in the field.

Thus, there is a strong need for an improved putting training and analysis system.

### SUMMARY

In an example embodiment, a mini-camera apparatus is disclosed that comprises: a mini-camera for recording images, from an overhead view, of a putting stroke, an electrical module connected to the mini-camera via a joint configured to aim the mini-camera for the overhead view of a putting stroke, wherein the joint is configured for adjusting the aim of the mini-camera view of the putting stroke.

In another example embodiment, a putting training system is disclosed comprising: a mini-camera apparatus comprising: a mini-camera for at least one of streaming and recording images, from an overhead view, of a putting stroke; an electrical module; a joint connecting the mini-camera and the electrical module to movably aim the mini-camera for the overhead view of the putting stroke; an attachment mechanism connected to the electrical module, wherein the attachment mechanism is configured to attach the mini-camera apparatus to a brim of a golf hat, cap, or visor, wherein the mini-camera is configured to record images. The putting training system further comprises: a mobile device; and a server, wherein the electrical module further comprises a wireless communication module, adapted to communicate with the mobile device for transmitting the image and the collected information; and wherein the mobile device is configured to generate statistics, analysis information, and notifications.

In yet another example embodiment, a method of providing analysis of a golf swing, the method comprises: receiving, at a mini-camera apparatus attached to a hat, a trigger to start recording overhead images associated with a golf swing; at least one of streaming and recording, using a mini-camera, overhead images associated with a golf swing; transmitting, via a transceiver, the streamed/recorded images to a mobile device; analyzing the streamed/recorded images; and displaying, on the mobile device while on the golf course, the streamed/recorded images with augmented display information providing analysis of the golf swing based on image processing and machine learning techniques, wherein the image processing and machine learning are based off of a known measurement of an object visible in the recorded images.

### BRIEF DESCRIPTION OF THE DRAWING(S

The present disclosure is illustrated by way of example and not limitation in the figures of the accompanying drawings in which like references indicate similar elements.

FIG. 1 shows a perspective view of an example mini-camera attached to a golf hat clip.

FIG. 2 shows a bottom view of the example mini-camera attached to a golf hat clip.

FIG. 3 shows an angled side view of a golfer wearing an example clip-on mini-camera apparatus.

FIG. 4 shows a side view of a golfer wearing an example clip-on mini-camera apparatus that is aimed at the golf ball on the putting green, capturing the overhead view of the putting stroke by adjusting the angle of the mini-camera.

FIG. 5 illustrates an overhead view image of a putting stroke motion as taken from the example clip-on mini-camera apparatus, showing a putter head, a golf ball, golfer’s hands, a pair of golfer’s golf shoes and putting green surface.

FIG. 6 illustrates an example augmented display of the analysis of the putting stroke motion that shows the angle of the putter head and the location of the impact between the putter head and golf ball.

FIG. 7 illustrates an example telescopic apparatus that is extendable in length.

FIG. 8 shows a schematic diagram of an example embodiment of the clip-on mini-camera apparatus.

FIG. 9 shows a USB port for recharging a battery in an example clip-on mini-camera apparatus.

FIG. 10 shows an example clip-on mini-camera apparatus connected to a mobile device and a mobile device to a network of servers, via wireless signal.

FIG. 11 illustrates an example thin film push button switch.

FIG. 12 shows an example SD card port for storing the information.

FIG. 13 illustrates a red light spot that is emitted from the example clip-on mini-camera apparatus and tracks the aim of the golfer’s head during the putting stroke motion.

FIG. 14 illustrates an example augmented display of the calculated slope of the putting green.

FIG. 15 is a flow chart showing an example of a method for using the system.

FIGS. 16A-D illustrate phases of a putting stroke with a reference stance line and a swing motion stance line for illustrating head movement of a golfer during a swing motion.

### DETAILED DESCRIPTION

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below. In the following detailed description, reference is made to the accompanying drawings that form a part hereof, and in which the specific embodiments that may be practiced are shown by way of illustration. These embodiments are described in sufficient details to enable those skilled in the art to practice the embodiments and it is to be understood that logical, mechanical and other changes may be made without departing from the scope of the embodiments. The following detailed description is therefore not to be taken in a limiting sense.

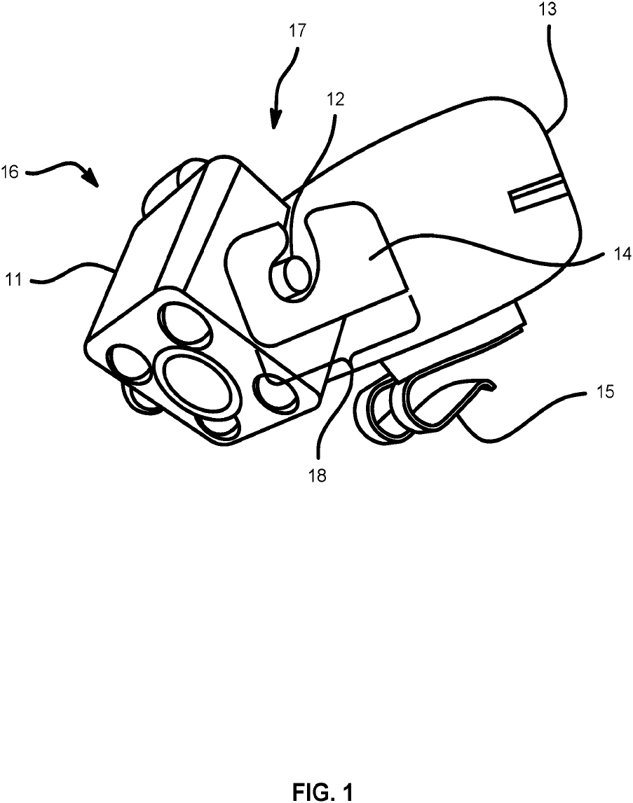

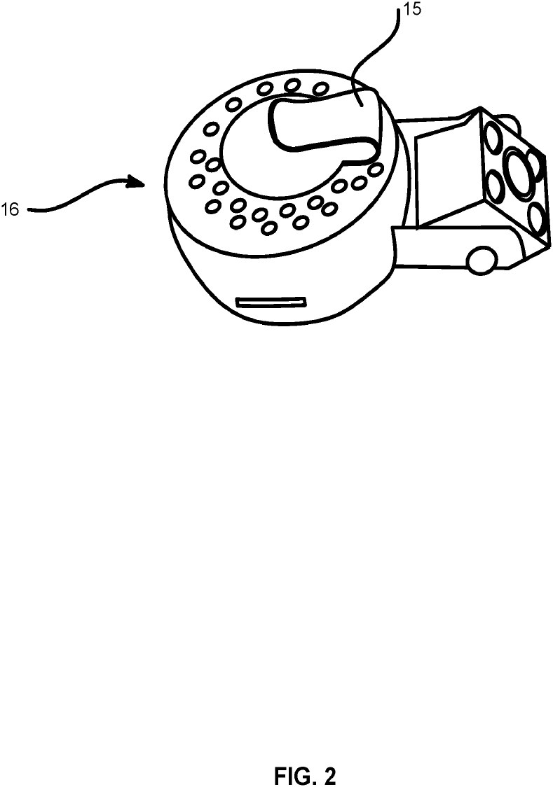

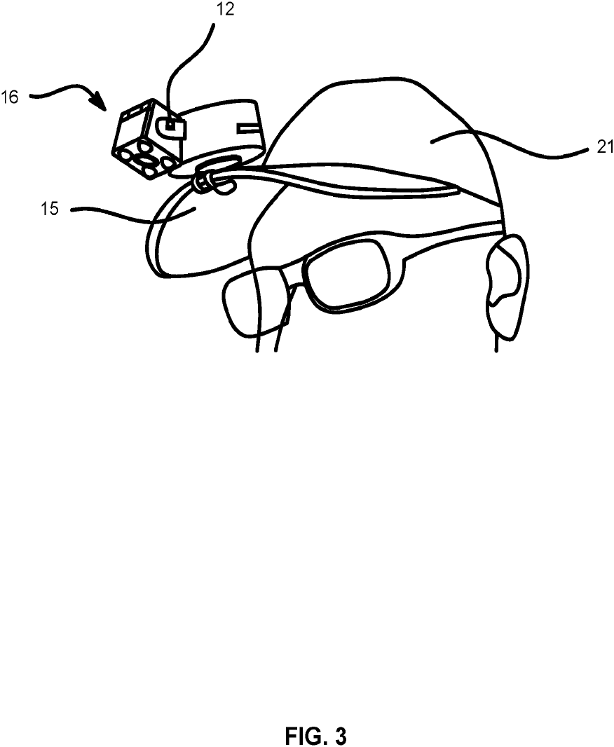

One example embodiment, shown in FIGS. 1 and 2, a clip-on mini-camera apparatus 16 may comprise a mini-camera device 17 and an attachment mechanism, such as a hat clip 15. The mini-camera device 17 may comprise a mini-camera 11 and an electrical module 13. In an example embodiment, the aim of mini-camera 11 can be adjustable using a joint 18 to aim the mini-camera to provide an overhead view image of the putting stroke motion. In an example embodiment, the mini-camera 11 is connected to the electrical module 13 which is connected to the attachment mechanism (e.g. hat clip 15). The mini-camera apparatus 16 is configured to live stream or record images from an overhead perspective from the vantage point of the head of the golfer looking down at the golf ball during an in-situ golf swing. The live-stream function may, for example, allow the golf pro or spectators to watch the putt in real-time from the perspective of the golfer.

In various embodiments, the term “mini-camera” or mini-camera 11 used in this description can refer to any compact camera, such as Relohas HD 1080p Wireless Mini Spy Camera, that can live-stream and record images. For instance, the mini-camera device 17 can be a mobile phone camera, compact digital camera, mini spy camera, or the like. The specifications for the camera performance are typically 1080p, also known as Full HD, and 30 frames per second. However, any suitable specifications may be used. The specifications are to be determined by the image quality requirements for training, analyzing, and instructing a golf swing motion, for example, a putting stroke motion. Therefore, the requirements for pixels and frames per second may decrease or increase accordingly. In one example embodiment, where high speed action is being live-streamed or recorded, the camera may comprise a high-speed camera of at least 4K resolution (i.e. 2840 x 2160 pixels), though any suitable resolution may be used.

The mini-camera apparatus 16 may further comprise a joint 18, and its line of sight may be adjusted to present a top-down view for a user. In an example embodiment, the joint 18 is configured for desirable relative movement between the mini-camera 11 and the base or electrical module 13, which is connected with the mini-camera 11 by the joint 18 and is fixed to the attachment mechanism 15. In an example embodiment, the mini-camera 11 may house the camera, optics, and/or other electrical components. In another example embodiment, the electrical module 13 is configured to house the electrical components and serves as more than just a base. The electrical components may comprise a processor, memory, and communication electronics, such as a transceiver (e.g., Bluetooth enabled communication), among other electrical components, and may be configured in any suitable manner for achieving the objects disclosed herein. In an example embodiment, the transceiver may be configured to wirelessly send image data (e.g., images of a putting stroke) to a mobile device.

In an example embodiment, joint 18 may comprise any kinematic joint permitting relative movement between the mini-camera 11 and the electrical module 13. In various examples, the joint 18 may allow one or more degrees of freedom of movement. In accordance with various examples, the joint 18 may comprise a revolute joint, such as a hinge or pin joint, or a composite joint, such as a ball or roller bearing. Without limiting the scope of this disclosure, in an example embodiment, the joint 18 comprises a pin 12 and a fixture 14. In this example embodiment, fixture 14 is attached to the electrical module 13 and the pin 12 is attached to the mini-camera 11, and the pin 12 is configured to rotate about an axis of rotation permitting the mini-camera 11 to rotate in one degree of freedom about the axis.

In an example embodiment, the joint 18 is configured for desirable relative movement between the mini-camera 11 and the electrical module 13, and for locking the mini-camera 11 in place relative to the electrical module 13 when the desired pointing is achieved. For example, the electrical device may comprise a locking pin (not shown) to lock the mini-camera 11 in place at a desirable position relative to the electrical module 13. Moreover, any suitable locking mechanism may be used to adjustably fix the mini-camera 11 pointing direction relative to the electrical module 13.

In an example embodiment, the joint 18 is configured to adjust the aim of the mini-camera 11. The adjustment can be a manual adjustment made when the device is attached to the hat or frequently during use. In another example embodiment, the adjustment can be made automatically to cause the aim of the mini-camera 11 to be pointed straight-down, for the overhead view of the putting stroke, regardless of the positioning of hat clip 15.

In another example embodiment, the mini-camera 11 and the joint 18 are configured so that the mini-camera 11 is always free to rotate to point in a desired direction regardless of the movement of the golfer. In one example embodiment, the desired direction may be straight down. In this example embodiment, the joint 18 may be configured to freely allow movement of the mini-camera 11 relative to the electrical module 13, and the mini-camera 11 may be weighted such that gravity will cause it to move on joint 18 to point straight down. The desired direction, in other example embodiments, may be at an angle relative to a vertical line straight down from the mini-camera 11. For example, the desired direction may be at an angle of 5 degrees away from the golfer from a vertical line straight down from the mini-camera 11. This can be achieved again by weighting the mini-camera 11 such that gravity causes it to hang at a 5 degree angle. Moreover, the mini-camera 11 may hang at any suitable angle. In other example embodiments, the desired pointing direction may be caused by gyroscope, motor, or any suitable aiming system.

As mentioned above, in an example embodiment, the mini-camera apparatus 16 further comprises an attachment mechanism. Attachment mechanism may be configured to attach the mini-camera apparatus 16 to a hat. Although described herein as a hat, it should be understood that this disclosure extends to visors, lids, caps, helmets, headgear, headpiece, headbands or to any other object that may suitably be worn on the head of a golfer. The attachment mechanism may, in an example embodiment, be a hat clip 15. In an example embodiment, the mini-camera device 17 is connected to the golf hat clip 15, by using glue, weld, magnets, Velcro® tapes, screws, or the like. In one example embodiment, the mini-camera device 17 is attached to the hat clip 15 by using male and female screws, for secure attachment. The mini-camera device 17 can be easily attached and detached as needed.

In one embodiment, a magnetic material such as a magnetic tape or other similar base plate is attached to the top surface of the clip-on mini-camera apparatus 16, and a golf accessory such as magnetic golf marker may be attached onto the mini-camera apparatus 16.

Although described herein in terms of a golf hat clip 15, this disclosure extends to any device that can attach the mini-camera apparatus 16 with adjustable angle mechanism to a hat, cap, or visor. In an example embodiment, the hat clip 15 can be similar to a golf ball mark hat clip such as PINMEI magnetic standard golf ball mark. In this example embodiment, a base clip may be clipped to the brim of a hat and the mini-camera device 17 may be removably magnetically connected to the hat clip 15. As shown in FIG. 3, in an example embodiment, the clip-on mini-camera apparatus 16 is clipped onto a golf cap 21.

A golfer wears the golf cap 21 where the clip-on mini-camera apparatus 16 is fixed by using the hat clip 15. The aim of the apparatus 16 is adjusted by using the joint 18 to aim the mini-camera apparatus 16 to provide the overhead view image of the putting stroke motion. By wearing the clip-on mini-camera apparatus 16, the golfer is able to take the clip-on mini-camera apparatus 16 anywhere to any golf course and at least one of stream and record the overhead view of the putting stroke on the actual putting green in a golf course.

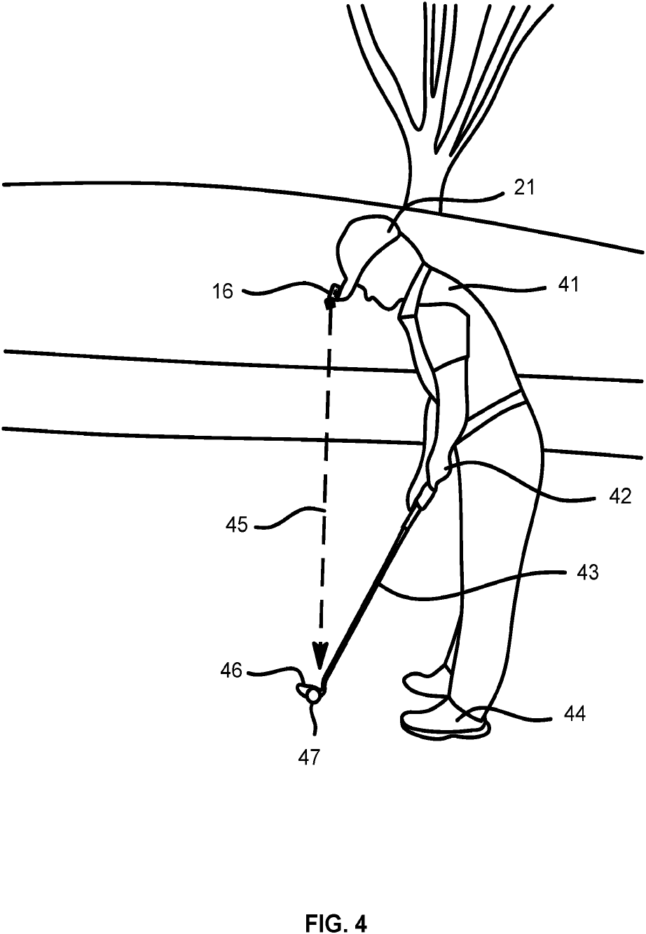

In FIG. 4, a golfer 41, wearing a golf cap 21 with the clip-on mini-camera apparatus 16 attached, bends over a golf ball 47 for a putting stroke by holding the putter with the hands 42 and placing the putter head 46 next to the golf ball 47. The golfer 41 views the putter head 46 and the golf ball 47 from the top-down view, i.e. overhead view. The golfer 41 adjusts the aim of the apparatus 16 by using the joint 18 to aim the mini-camera to capture the desired overhead view of the putting stroke. The dotted line 45 illustrates that the clip-on mini-camera apparatus 16 is aimed to provide the overhead view as the golfer 41 views the putting stroke motion. The view may take in the golf ball 47 and the putter head 46. The view may also take in one or more of the following: the golfer’s hands 42, putter shaft 43, golfer’s shoes 44.

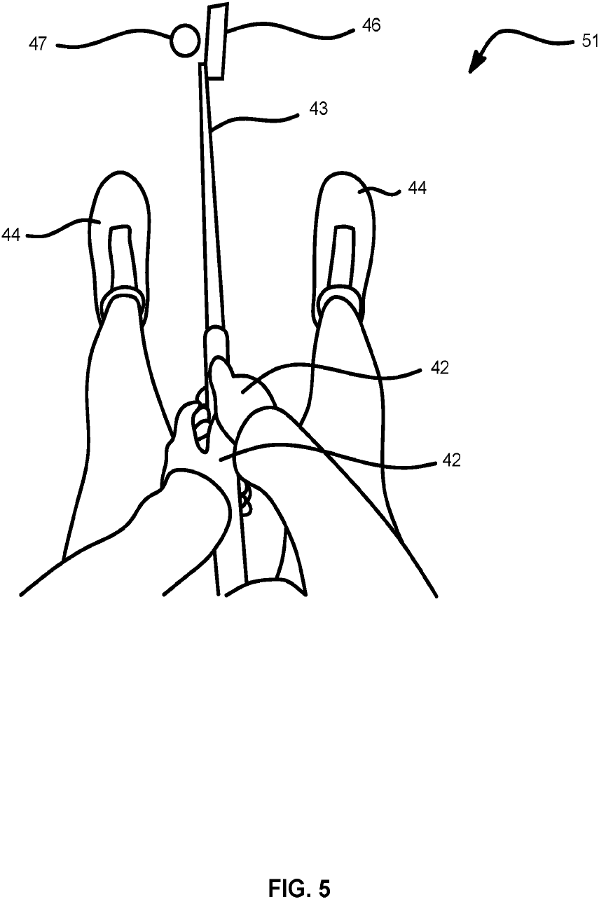

With reference now to FIG. 5, the system may further comprise a display screen, such as a screen 51 is illustrated. The system may be configured to display, on screen 51, an overhead view still image from the video, previously captured by the apparatus 16 shown in FIG. 4, obtained at the moment when the putter head 46 is addressed at the golf ball 47 in the putting stroke. In the example embodiment, the golf ball 47 and putter head 46 are detected by using image processing techniques. In another example embodiment, the machine learning techniques are used in addition to image processing methods in order to improve the automation, accuracy, and speed of detection and tracking of the objects of interest such as the golf ball 47 and putter head 46.

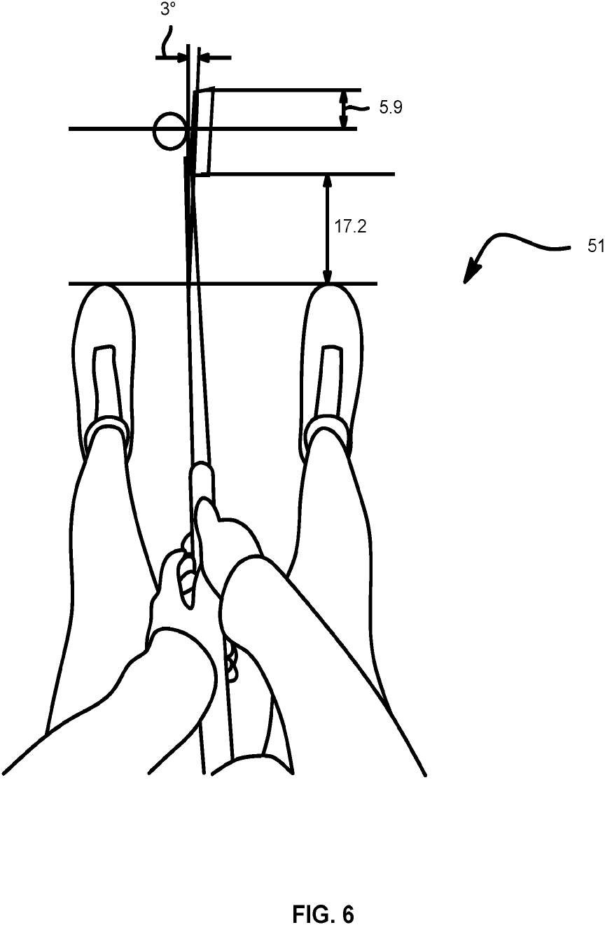

With reference now to FIG. 6, the system may further be configured to display, on screen 51, an augmented display of analysis information. The analysis information may comprise any information useful for improvement of the observed activity. In the context of putting, the analysis information may comprise any information useful for improvement of the golfer’s putting game. However, the analysis information may comprise different information depending on the observed activity. For example, if the observed activity is chipping, driving or hitting irons, the analysis information may comprise information of improving the relevant part of the golfer’s game. If the observed activity is swinging a baseball bat, the analysis information my comprise information relevant to improving the baseball player’s batting. If the observed activity is swinging a tennis racket, the analysis information may comprise information relevant to improving the tennis player’s game. If the observed activity is billiards, the analysis information may comprise information relevant to improving the billiards player’s game and may be based on a standard pool ball size. If the observed activity is ping pong, the analysis information may comprise information relevant to improving the ping pong player’s game and may be based on a standard ping pong ball size. Moreover, the apparatus 16 may be configured to provide analysis information for any activity that benefits from an overhead (top-down perspective) view of a defined activity performed by a person where at least one object of standard size is typically available in the overhead view.

With continued reference to FIG. 6, and in the example embodiment where the observed activity is putting, the screen 51 is configured to display an image (either streaming or previously taken of the putting activity), and augment the display by displaying the analysis information that is obtained by computer vision techniques (or image processing techniques). For example, the image may include the golfer’s shoes, legs, hands, the putter and the golf ball. The image may further include the putting surface, the hole, the pin, or any other images recorded by the mini-camera apparatus 16.

In an example embodiment, the displayed analysis information may include reference lines, angles, distances, and or the like. Reference lines may be displayed, for example, showing a line drawn from the toe of the golfer’s two shoes. A reference line may be drawn parallel to the putter face, and one may be drawn perpendicular to the putter face at any of: the sweet spot, the center, or the point of impact of the golf ball of the putter face. In another embodiment, reference lines may be drawn perpendicular to the putter face extending in either direction from the toe or the heel of the putter face. Moreover, reference lines may be drawn showing a line perpendicular to the path of the ball at impact and/or any line useful for showing relative distances or angles of the displayed images.

In an example embodiment, the analysis information may further include text / data quantifying relative distances or angles between one or more of said reference lines. For example, the screen 51 may display augmented analysis information showing and quantifying the angle of the putter head 46 relative to the path of the ball at impact (a line parallel to the putter face relative to a line perpendicular to the putter face at the point of impact). The angle may be displayed, for example in degrees or radians. In the illustrated embodiment of FIG. 6, the screen 51 displays the putter angle as 3 degrees at the point of addressing the ball. Moreover, the augmented analysis information may be displayed in any suitable manner for showing how far off the actual putter face orientation (at impact) is relative to a desired putter face orientation.

The augmented analysis information may, for example, display the exact location of contact, at impact, on the face of the putter, between the putter head 46 and the golf ball 47. For example, the screen 51 may display the distance between the point of impact and the toe of the putter, the heel of the putter, the center (halfway between the toe and the heel of the putter, and/or the sweet spot of the putter.) In the illustrated embodiment of FIG. 6, the screen 51 displays the distance from the toe of the putter to the point of impact as 5.9 centimeters. Moreover, the augmented analysis information may be displayed in any suitable manner for assisting a golfer in knowing how far off putter point of impact (the deviation) is from a desired point of impact or how much variation in the point of impact exits between putts.

The augmented analysis information may, for example, display the location of the putter head 46, at impact, relative to the golfer’s shoes. For example, the screen 51 may display the perpendicular distance between heel of the putter, at the point of impact of the putter face with the golf ball, and a line drawn between the toes of the shoes of the golfer. In the illustrated embodiment of FIG. 6, the screen 51 displays this distance from the toes of the shoes of the golfer to the heel of the putter as 17.2 centimeters. Moreover, the augmented analysis information may be displayed in any suitable manner for showing the location of the golf ball 47 with respect to the golfer’s shoes 44, and/or how far the golfer is reaching out to make the putt.

Moreover, the augmented analysis information may comprise any suitable graphic or text for providing information useful for improving, commentating on, sharing, comparing, and/or analyzing the observed activity. In an example embodiment, the augmented analysis information may be based on image processing to identify reference lines and the angles between them. In an example embodiment, the augmented analysis information for distances may be determined based on image processing that further uses scaling to determine the size of objects and/or distances between reference lines or points based on the size of an object captured in the image (where the object has a known size). In an example embodiment, there is at least one object of known size in the image. In another example embodiment, the object of known size is captured in at least one image of multiple images captured relatively close in time to the image being analyzed such that the scaling is still applicable. In particular, in an example embodiment, the object of known size is a golf ball. The USPGA requires all golf balls to be of a set diameter, e.g., 42.67 mm in diameter. While this is unlikely to change, in various example embodiments, the size of the known object can be any suitable size. In another example embodiment, if the make and model of the putter is known, the size of the putter head can be the known object size for the analysis. The object of known size may be referred to herein as the calibration object.

The augmented analysis information may further comprise additional “measured” parameters, including “measured” parameters of movement. These movement parameters may be determined for example, by image processing involving multiple frames of images or video processing. For example, the system may be configured to analyze the speed of the putting stroke, the direction of the ball movement after impact, and the speed of the ball movement after impact, the putter path, the golf ball acceleration, angular acceleration and/or velocity of the golf ball, spin of the golf ball, putter head acceleration/deceleration, transfer of momentum, the position of the contact between the putter head and the ball at impact, the angle and distance of the golfer’s head movement, the angular and spatial acceleration/deceleration of the golfer’s head movement, the angle of the movement of the golfer’s wrists, the golfer’s grip position of the putter, the golf ball position relative to the golfer’s feet, etc. Moreover, the system may be configured to determine this information based on image processing techniques based on the size of an object of known size captured in one or more of the images being processed.

Thus, the golfer 41 and/or an instructor may analyze the golfer’s putting through review of the camera image(s) and/or augmented analysis displayed on the display screen. In one example embodiment, the golfer and/or instructor may evaluate the putting stroke plane or line by reviewing the recorded video of the putting stroke and the overhead view still images before and after the point of the impact between the putter head 46 and the golf ball 47. When the overhead view image is reviewed at the golfer’s address to the golf ball 47, the grip of the golfer’s hands 42 and the position of the putter head 46 may be evaluated and the ideal characteristics of the putting stroke may be determined for the golfer 41.

The overhead view of the image at the putting address may also facilitate an analysis of the ball movement such as the speed and the path of the ball. In an example embodiment, the system is configured to generate valuable information about one or more of the putting greens for a specific golf course. This information is valuable to learn the characteristics of the actual putting green in the golf course. In an example embodiment, the system is configured to analyze the putting stroke motion in the context of the specific green being played for that stroke, and/or the specific location on the green for that stroke. Thus, the augmented display may improve the golfer’s stroke in the context of the slopes and speeds of the actual green and location on that green. Thus, the augmented display may be configured to provide a more complete or wholistic training feedback in order to improve the golfer’s putting game and ultimately lower the golf score.

Although any suitable lessons can be taught using the augmented display information, in one example embodiment, the golfer 41 may be able to visually see where on the putter head 46 “impact location” (between the toe and heal of the putter face) the golfer 41 strikes the ball 47 compared to previous putts, compared to an ideal putt, compared to the golfer’s own preferred location, etc. The golfer 41 may learn that they tend to vary that impact location based on how tired they are, the slope of the green, the length of the putt, the distance of the back swing, or other factors. Thus, the system may be configured by using machine learning or data science principles such that the golfer may be able to quantify impact location consistency, head movement data (e.g., speed, angle, acceleration and amount of head movement), and/or work towards measurable improvement based on this information.

Although this description principally discusses obtaining the augmented display information based on image processing algorithms, in some example embodiments, augmented display information may be obtained by or based on GPS data, 3D slope readers, accelerometers, sensors, and/or the like. The augmented display information, in other example embodiments, may be based on data input by a golfer 41 or received from external sources. For example, a golfer 41 may enter information about the make and model of the golfer’s putter, swing preferences, and/or the like. Or, the information may be configured through machine learning algorithms by using the accumulated data. The augmented display information could then be based on the golfer’s input swing preference, or data looked up from a database about the golfer’s golf club. In various example embodiments, the augmented display information may be based on a combination of two or more of any of these sources of information.

In an example embodiment, the system may be configured to allow a user to select display options for the viewing of the mini-camera recordings. The display options may include, for example, zoom options, viewing the recorded images frame by frame, viewing video of the putting stroke, or live-stream display of the putting stroke. In any of these viewing embodiments, the augmented analysis may be included on the display. In an example embodiment, this is accomplished through stitching the frames together with corrections to ensure continuity and the like.

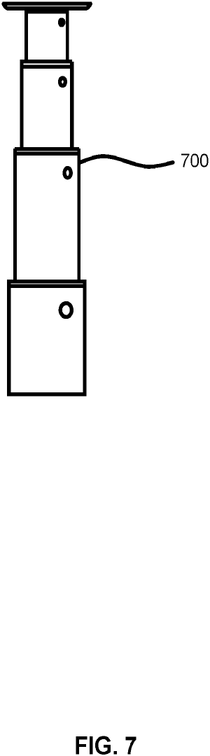

With reference now to FIG. 7, in one example embodiment, the fixture 14 of the mini-camera apparatus 16 may comprise an extendable apparatus. For example, the extendable apparatus may be a telescopic structure 700. In an example embodiment, the extendable apparatus is a telescopic rod. The extendable apparatus may be configured to adjust the position of the mini-camera 11 by adjusting the distance between the mini-camera 11 and the electrical module 13. The extendable apparatus may be configured to adjust the position of the mini-camera 11 by adjusting the distance between the electrical module 13 and the hat clip 15. Moreover, the extendable apparatus may be any suitable structure configured to provide the desired overhead view of the putting stroke motion per the shape, size, stance, and posture of a golfer. Thus, the extendable apparatus can change the vantage point of the mini-camera apparatus to better capture the putting stroke motion.

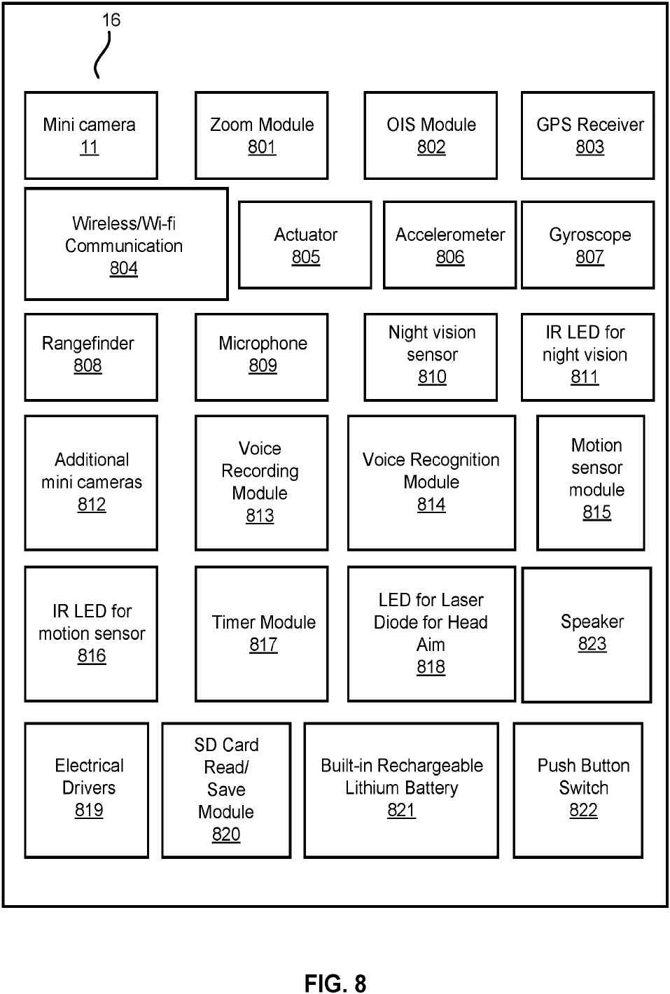

With reference now to FIG. 8, various example components of the mini-camera apparatus 16 are discussed. One or more of these example components may comprise a part of a practical mini-camera apparatus 16. In an example embodiment, the mini-camera apparatus 16 comprises the mini-camera 11 as described elsewhere herein. In another example embodiment, the mini-camera 11 comprises a zoom module 801, configured to adjust the focal length of the image(s)/video to generate clear overhead view images of the objects relevant to the analysis of the putting stroke motion. Those relevant objects may include one or more of the putter head 46, the golf ball 47, the putter shaft 43, the green ground surface, and the like. The zoom module 801 may be configured to generate such clear images despite variations in the distance between the clip-on mini-camera apparatus 16 and the golf ball 47. These variations may arise due to the golfer’s height, posture/stance, the putting green surface’s modulation, and/or for other reasons. The zoom module 801 may thus be configured to facilitate capturing the overhead view images of the putting stroke motion and the ball movement per the required image quality in relation to the image processing algorithms in use. The zoom module 801 may be implemented, for example, using electronic zoom techniques, or any suitable physical zoom components, such as zoom lenses and actuators to adjust the focal length of the images.

In various embodiment, a mini-camera module is equipped with lenses with a wide angle of view to capture the area of interest. The angle of view is nominally 140 degrees and may be set to an adjusted value per the scope and goal of the putting stroke motion analysis, for instance between 80 degrees and 240 degrees, and in another example between 50 degrees and 240 degrees.

In one embodiment, the clip-on mini-camera apparatus 16 comprises a module 802 that is configured to detect small movements of the clip-on mini-camera apparatus 16 and compensate for any blur of the images by using optical image stabilization (OIS) technology. For example, the OIS module 802 may comprise a gyroscope 807 that detects the small movement and actuators 805 to move the lenses in real time to compensate for the small movement. Moreover, any suitable OIS technology may be used to enhance image quality.

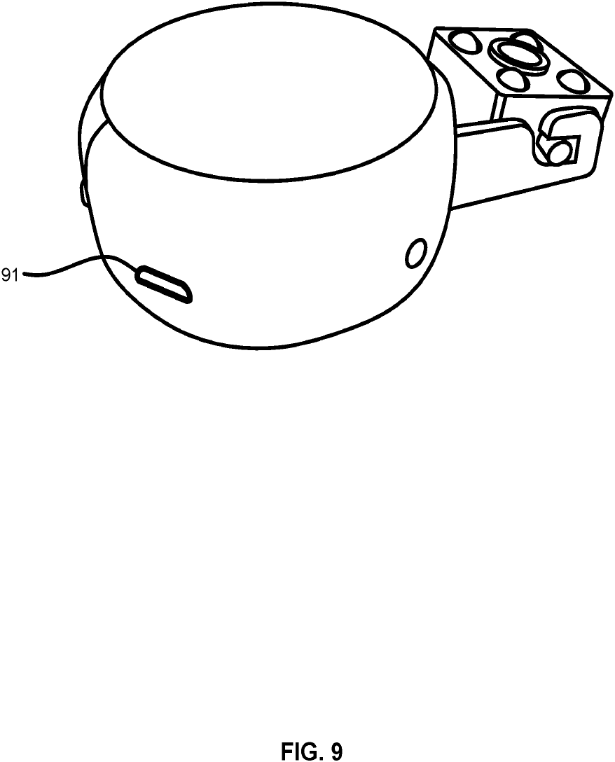

Referring to FIGS. 8 and 9, in an example embodiment, the mini-camera apparatus 16 further comprises a battery. For example, the mini-camera apparatus 16 may comprise a built-in rechargeable Lithium battery 821 which is recharged by, for example, using the USB cable through the port 91. Moreover, any suitable energy storage device may be used.

In an example embodiment, the clip-on mini-camera apparatus 16 comprises a GPS module 803. The GPS module 803 may be configured to detect the location where the putting strokes have been performed.

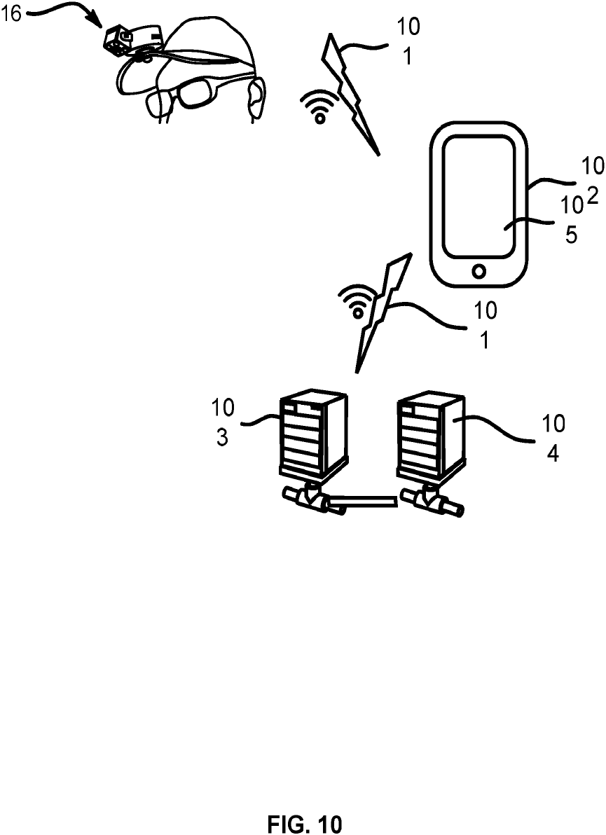

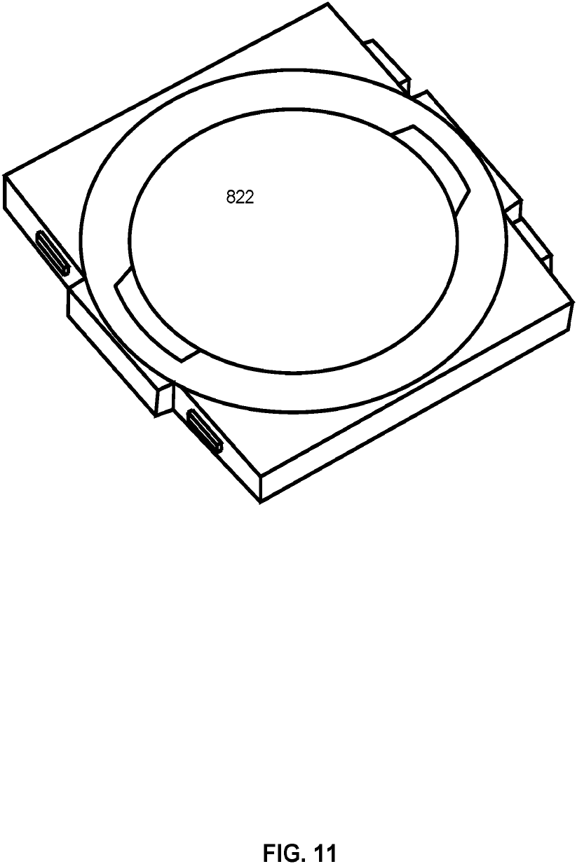

In an example embodiment, and with reference to FIGS. 8 and 10, the mini-camera apparatus 16 comprises a wireless communication module 804. The wireless communication module 804 may be configured to communicate wirelessly 101 with a mobile device 102. The mobile device 102 may be configured to communicate with an application server 103 and/or a cloud server 104. In accordance with other example embodiments, the mini-camera apparatus 16 may comprise a communication module adapted to use a cable (such as, for example, a USB C-type cable) that connects the mini-camera apparatus 16 with a mobile device 102, tablets, and a computer for transferring data between the devices and/or for charging the mini-camera apparatus 16.

In one embodiment, the mini-camera apparatus 16 comprises accelerometers 806 and gyroscopes 807. The accelerometers 806 and gyroscopes 807 may be configured, for example, to create motion-based data. Herein, the motion-based data means that the data was not derived from images. Rather the motion-based data was derived from sensors that directly measure motion. The motion-based data may include speed, acceleration, orientation, direction, and the like in relation to the putting stroke address and putting stroke motion before, during and after the putting stroke. But it is noted that image-based data may also include speed, acceleration, orientation, direction and the like, but derive it in this different way.

In one embodiment, the mini-camera apparatus 16 comprises a rangefinder module 808. The rangefinder module 808 may be configured to measure the distance between the clip-on mini-camera apparatus 16 and one or more objects of interest (e.g., the golf ball 47, the ground, etc.) based on the Time-of-Flight (TOF) principle. The rangefinder module 808 may comprise any suitable rangefinder device (e.g., optical, sonar, radar, lidar, and/or the like). In an example embodiment, distance information is tracked to monitor the position of the mini-camera apparatus 16 relative to a golf ball 47 viewed through the mini-camera.

In one embodiment, the mini-camera apparatus 16 comprises a night vision module 810. Night vision module 810 may be configured to see and record by using a sensor and infrared (IR) Light Emitting Diodes (LEDs) 811. In this embodiment, the night vision module 810 may be configured to automatically turn on and off the night vision function, to manually turn on and off the night vision function, or to do so by default setting. Thus, the mini-camera apparatus 16 is configured such that when a golfer 41 is putting at dusk, twilight or dawn, the image of the putting stroke can still be displayed and recorded so as to be easily perceived on screen 51.

In an example embodiment, the clip-on mini-camera apparatus 16 may comprise multiple mini-camera modules 812 where each one of said multiple mini-camera modules is configured to capture an overhead image of the golf swing. In this example embodiment, the system may further comprise code for processing the images from each of the multiple mini-camera modules 812 to improve zoom performance, achieve wide-angle view, enhance images with blurred background, achieve high quality of full color, measure the distance between the mini-camera apparatus 16 and the golf ball 47, and/or enhance augmented reality data, to name a few. Each mini-camera module 812 may have different specifications of pixels and frames per second, for examples, with different types of the wide-view lenses, zoom modules 801, and OIS module 802 per the system requirements.

In one example embodiment, the clip-on mini-camera apparatus 16 comprises a microphone 809 and voice recording module 813 that records voice information. This information can include instruction that was given to the golfer during the golfing, or any other desirable information. The voice information is recorded and can be played at a later time which helps the golfer 41 conveniently access the information that was discussed with the instructor on field. It is noted that audio recordings can be made from microphones 809 on the mini-camera apparatus 16, on a mobile device, or on any other suitable device, and the audio recordings can be transmitted from the recording device to various devices and can be played back on the various devices as well.

In one embodiment, the clip-on mini-camera apparatus 16 comprises a voice recognition module 814 that recognizes the user’s voice and processes voice commands to initiate and stop the operation of the apparatus 16 including the image recording, voice information recording and the motion-based data acquisition.

In one embodiment, the clip-on mini-camera apparatus 16 comprises a speaker 823. The user may hear instructions through the speaker 823 from the computer code-generation such as artificial intelligence (AI) algorithms, or an instructor who is remotely viewing the live-streaming video images.

In one embodiment, the clip-on mini-camera apparatus 16 comprises a motion detection sensor module 815 and infrared (IR) light source such as LED 816 that detects pre-programmed motion command(s) to initiate and stop the images recording and data acquisition. Although described as a motion sensor and IR light source detector, any suitable sensors can be used to detect pre-programmed motion commands. In one embodiment, and with reference to FIGS. 8 and 11, the clip-on mini-camera apparatus 16 comprises a push button switch 822 which is configured such that the golfer 41 can push it to manually turn on and off recording the image and voice data, and collecting the golf data. The push button switch 822 may be a thin film based button and installed on the top of the clip-on mini-camera apparatus 16. However, any suitable switch, button, or manual device may be used to trigger the starting and stopping of various functions of the mini-camera apparatus 16.

Moreover, in an example embodiment, the mini-camera apparatus 16 may comprise a timer module 817. The timer module 817 may be configured to initiate and stop the image recording and data acquisition in accordance with pre-programmed timer settings. For example, the timer module 817 may be configured to start recording images five seconds after the push button switch 822 is pressed. In an alternative embodiment, the user operates timer function by using the mobile device app to trigger the start and stop of recording based on user inputs on a mobile device. In another example embodiment, the user may input a duration of recording, such that the mini-camera apparatus 16 records for a user input length of time after recording is initiated, and then stops. Moreover the timer module 817 may be configured in any suitable manner to initiate/terminate image recording and data acquisition in an automated or semi-automated way. In an example embodiment, timer module 817 is configured to save data storage space and/or power consumption, as well as provide a convenient method of turning on/off the device.

In another example embodiment, the mini-camera apparatus 16 may be configured to turn on and off the recording and data acquisition based on image processing algorithms. For example, the code may be configured to predict that the movement of the golf ball may be leaving the frame and use that prediction to stop the recording and data acquisition. In another example embodiment, the code may be configured to continuously analyze frames of images and start recording the images and data acquired several frames before a particular detected movement of an object of interest, such as a golf ball or putter head. Moreover, any suitable artificial intelligence routines may be used to determine the images and data that should be saved from those received by the mini-camera apparatus 16.

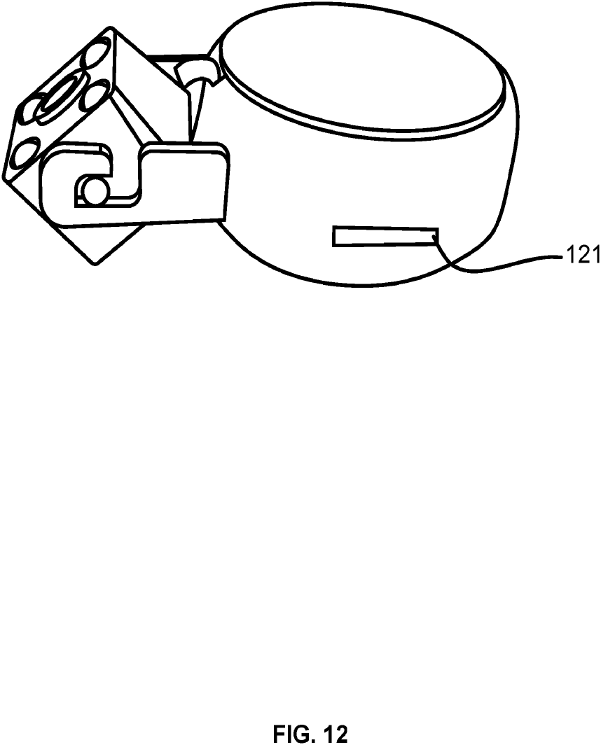

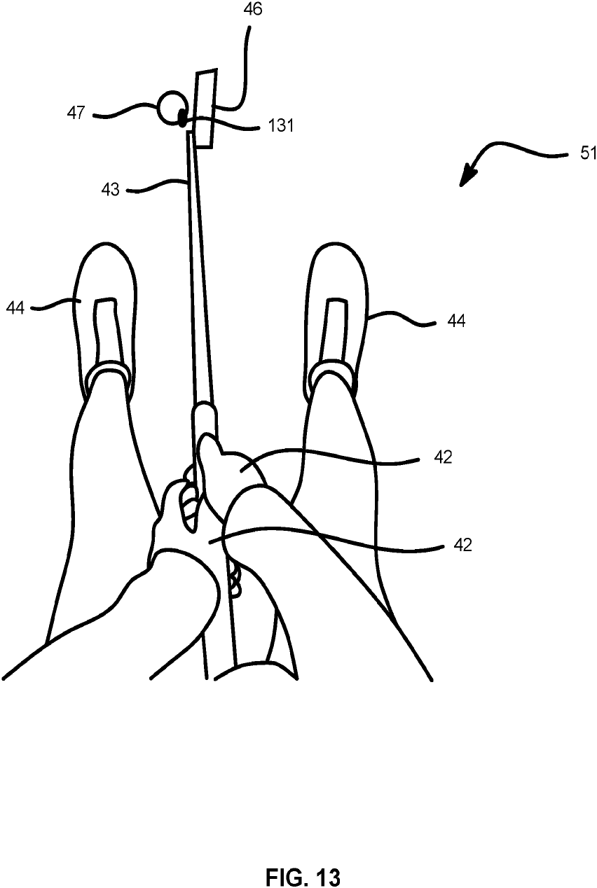

In one embodiment, the clip-on mini-camera apparatus 16 may comprise a memory or information module 820. The information storage module 820 may be configured to save the images and the collected data in a memory medium such as a micro SD card and/or to auto turn on loop recording mode. In an example embodiment, the mini-camera apparatus 16 may be adapted for physically connecting to a portable storage medium to save the image and other collected information. In an example embodiment, the portable storage medium may be a micro SD card or the like. Referring to FIG. 12, a SD card port 121 is shown in electrical module 13. Referring to FIGS. 8 and 13, in one embodiment, the clip-on mini-camera apparatus 16 comprises at least one light source 818 such as laser diode or light emitting diode (LED) that is used to show the position of the golfer’s head with respect to the putter head 46, the golf ball 47, and the golfer’s shoes 44 by shining a light spot 131 (for example, the example illustration of the red light spot) at visible wavelength (e.g. 400 nm to 740 nm). The golfer 41 sees the visible light spot 131 on the putting green surface, monitoring the angle and direction of the golfer’s head. Thus, in an example embodiment, the visible light spot 131 provides real time feedback to the golfer 41 of the golfer’s ability to keep a steady, motionless head during a putting stroke. The light spot may be recorded in the images taken during the putting stroke. In an example embodiment, the display 51 is configured to display the light spot 131 as part of the augmented analysis information. The golfer 41 may see whether the light spot 131 moves during the stroke or is steady on a fixed spot, whether the light spot 131 is aimed at a desired spot, such as at the golf ball 47 or a location forward of or behind the golf ball, etc.

In another embodiment, the light source 818 uses an infrared wavelength range (e.g. 741 nm to 1870 nm) and the camera’s image sensor is configured to detect the infrared light. The system is further configured to display the infrared image of the spot on the display of the mobile device 102, to show the relative location of the golfer’s head to the other objects displayed thereon, such as the golfer’s feet, club head, hands and ball.

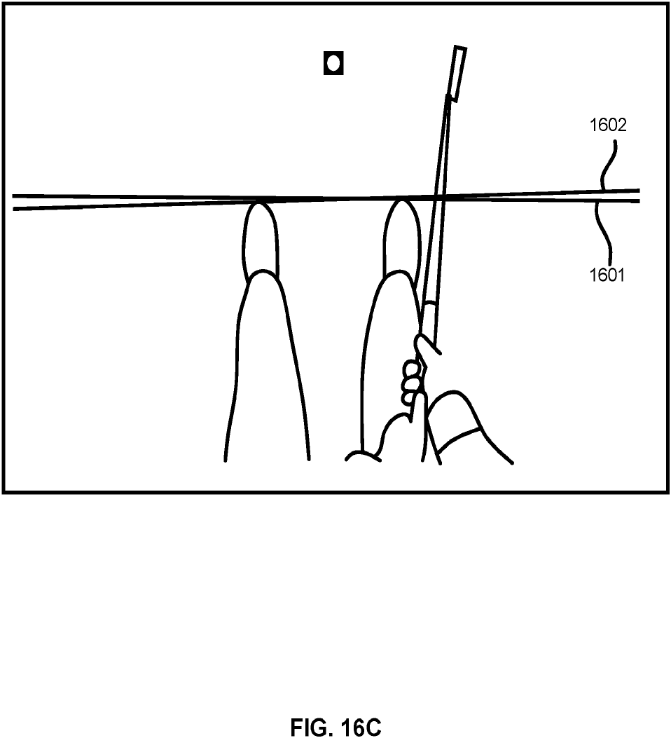

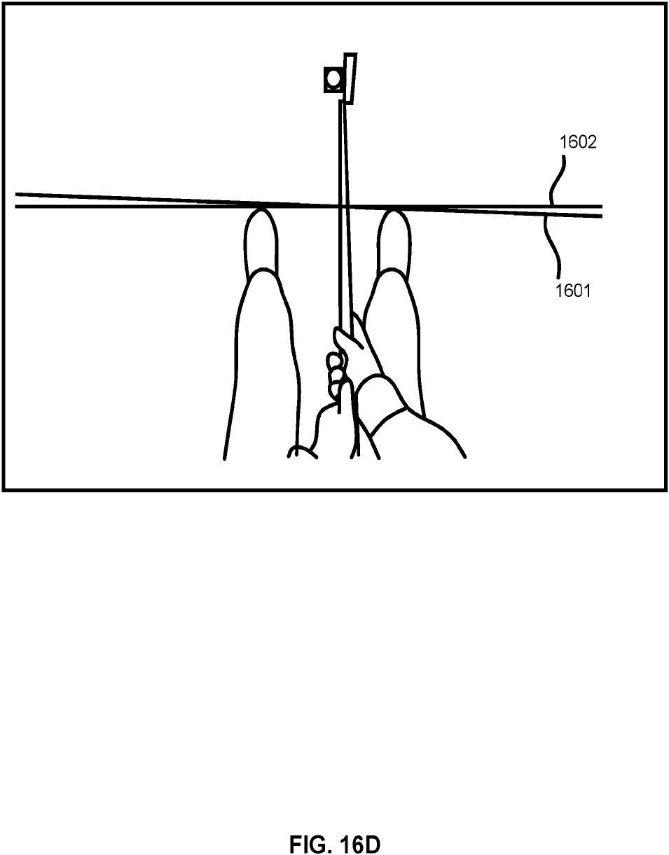

Apart from the visible indicator described above, in an example embodiment, the mini-camera apparatus 16 is configured to generate augmented analysis of a golfer’s head movement before, during and/or after a putting stroke through use of image processing. In this example embodiment, and with reference now to FIGS. 16A, 16B, 16C, and 16D, in an example embodiment, the system is configured to detect the golfer’s shoes’ tips either manually by the user entering the positions through the touch screen of the mobile device 102, or automatically by using the algorithms such as AI (Artificial Intelligence), machine learning and image recognition techniques. The four image frames in FIGS. 16A-16D show the sequence of a putting stroke. The line 1601 between the shoes’ tips defines the golfer’s stance line at the address of the putting stroke (FIG. 16A). During the putting stroke, the stance line is being tracked in each video frame. The reference stance line 1601 is defined by the stance line at the golfer’s address at the golf ball. It is extremely unlikely that a golfer moves their feet, i.e., their stance line, while the putting stroke is in action such as backswing, hitting a golf ball, and follow-through swing. Therefore, if the swing stance line 1602 in subsequent frames is changed with respect to the reference stance line 1601 during the putting stroke, the difference correlates to the golfer’s head movement. Moreover, the relative movement of other, typically static, objects during the golf swing may be indicative of the golfer’s head movement. In an example embodiment, the golfer’s head movement may cause the change of the relative position of the golf ball and the putter head in the given video image frame. In another example embodiment, the golfer’s head movement may change the line of sight, leading to the change of the relative position of the golf ball and the putter head in the given video image frame. The analysis presents the golfer’s head movement data, augmented analysis, such as angular amount of head movement, angular velocity of head movement, angular acceleration of head movement, head movement distance, and the like, before, during, and after the putting stroke. The augmented analysis information may, in an example embodiment, show the angle of the golfer’s head (by displaying a numerical angle or visual representation of the same).

More generally, the mini-camera apparatus 16 may be configured to use image processing to compare changes in relative positions of one object in the image to another object in the image, over a series of images to determine the relative movement of an object of interest. Stated another way, in an example embodiment, the image processing algorithm uses the relative position data, such as the coordinate points in terms of pixels of the image frame, among the golf ball, the putter head face line, the golfer’s stance line, the golfer’s hands, and any visible object such as a ball marker near the golf ball in order to determine the movement of an object of interest. Thus, the same technique may be used to determine the movement of the hands, the knees, etc. In varying embodiments, as shown in FIG. 8, the clip-on mini-camera apparatus 16 comprises electrical drivers 819 configured to operate the devices and modules that are illustrated in FIG. 8. The electrical drivers 819 may comprise any suitable hardware and/or software to implement the systems described herein. In one embodiment, the electrical driver 819 may be configured for simmer operation by which the apparatus turns on and off only during its operations instead of keeping it on all the time during the training round of golf. This feature saves the battery power in the mini-camera apparatus 16.

In one example embodiment, an optical polarizing filter may be attached to the clip-on mini-camera apparatus 16 to reduce any glare and reflection, from bright sunlight and the like, and therefore improve image quality, for example, under bright sunlight.

In one example embodiment, as illustrated in FIGS. 8 and 10, the system comprises a wireless communication module 804 that transmits information via Wi-fi, wireless Hotspot, LTE, Bluetooth, or the like, 101 between the mini-camera apparatus 16 and a designated mobile electronic device 102 and between the mobile device 102 and one or more of an application server 103 and a cloud server 104. In an example embodiment, the information being communicated from mini-camera apparatus 16 to mobile device 102 and/or to application server 103 and/or cloud server 104 may comprise one or more of: Video streaming, images, GPS location information, Accelerometer data (e.g. acceleration data), gyroscope data (e.g. orientation, angular velocity), Audio data, light intensity data (to turn on/off dark mode on mobile device screen), and/or the like. In an example embodiment, the information being communicated from application server 103 and/or cloud server 104 and/or mobile device 102 to mini-camera apparatus 16 may comprise one or more of: Video recording on/off command, microphone on/off command, laser pointer on/off command, digital zoom command, and/or the like.

The information communicated may comprise one or more of: the images recorded by the mini-camera 11, the location data obtained by the GPS module 803, the motion-based characteristics measured by the accelerometers 806 and/or gyroscopes 807, the distance between the mini-camera 11 and the golf ball 47 measured by the rangefinder module 808. Moreover, the information may comprise any suitable golf putting characteristics generated by using different sensors and devices in the mini-camera apparatus 16.

In various example embodiments, the image processing and analysis described herein and performed to implement the functions described herein may be executed on the mobile device 102, at the application server 103, at the cloud server 104, on the mini-camera apparatus 16, and/or distributed across two or more of these devices.

In varying embodiments, the system comprises all or any combination of the various modules, as shown in FIG. 8, in one apparatus package or into a number of separate packages.

Referring to FIGS. 8 and 10, an embodiment illustrates a clip-on mini-camera apparatus 16 that is linked to a mobile electronic device 102 by using mobile app 105. In an example embodiment, the system is configured to display the recorded images and collected data on a single or multiple mobile electronic device(s) 102 by using a mobile app 105. In an example embodiment, the system is configured to transfer and save the recorded images and collected data to a remote application server 103 and/or cloud server 104. In an example embodiment, the system is configured to process the recorded images and collected data for statistics and analysis on the mobile electronic device 102 or the remote application server 103. In an example embodiment, the system is further configured to post the recorded images, collected data, statistics, and analysis information to a user’s account, social network sites and the like.

In varying embodiments, the system comprises a mobile device application 105 that runs on a mobile device 102 used by the golfer 41 and/or the accompanying instructor. In other example embodiments, the system comprises a web app that runs on the mobile device 102. Thus in an example embodiment, the mobile device 102 is configured to use either a web app and/or a mobile device application to display images and information to the golfer. In an example embodiment, the mobile device application 105 or web app comprises one or more of the following electronic modules/applications/code:
a. Code for displaying the image transmitted from the clip-on mini-camera apparatus 16,
b. Code for operating the clip-on mini-camera apparatus 16, such as turning on and off, digital zoom, taking pictures, and the like,
c. Code for processing the image transmitted from the clip-on mini-camera apparatus 16 such as zooming, slow motion play, high speed forward or backward play, saving either each frame or a streaming video in the mobile device 102 and/or the server,
d. Code for receiving the collected data from the various sensors in the clip-on mini-camera apparatus 16 and transmitting them to the application server 103 and/or cloud server 104,
e. Code for displaying the information that is transmitted from the sensors in the clip-on mini-camera apparatus 16,
f. Code for displaying a manual entry form regarding information needed for analyzing the putter stroke motion and ball movement,
g. Code for displaying the images and the analytic information in the form of a table, plot, and/or graphical representation superimposed on video image frames,
h. Code for playing and recording the audio information that is transmitted and received between the clip-on mini-camera apparatus 16 and the application server 103 (or cloud server 104) or stored in the application server 103 (or cloud server 104),
i. Code for transmitting, receiving, and managing the information between the mobile device 102, an application server 103, and a cloud server 104,
j. Code for storing and retrieving the user’s information, the images from the mini-camera apparatus 16, collected data, and analytic information in mobile device’s memory medium, the application server 103, and the cloud server 104,
k. Code for displaying images from multiple of mini-camera modules 812,
l. Code for allowing multiple users to view the images, collected data, statistics, analysis results, instructions, and the like in multiple of authorized mobile devices 102,
m. Code for registering and logging in a membership account where the user’s information is managed including the profile information, putting stroke motion data, ball movement data, analysis, instructions, head movement data, relative hand location data, relative hand grip data, and the like,
n. Code for sharing the images, audio, collected data, statistics, analysis results, instructions and the like by using a social media application interface,
o. Code for searching for instructors or students using a social media application interface,
p. Code for posting instruction information in images, audio, and the combination of both to a user’s account, and/or
q. Code for stabilizing the video image frames, adapted to compensate any blur of the image due to small movements of the mini-camera apparatus.

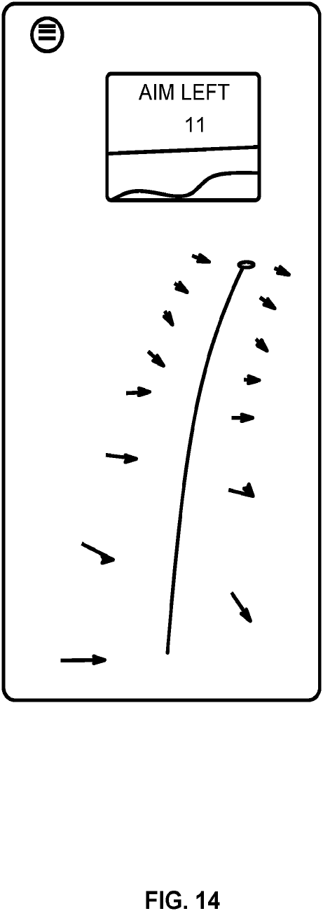

In one embodiment, as shown in FIG. 14 (for example, Golf Slope product’s display is shown in FIG. 14), the mobile device app 105 comprises code for creating the three-dimension augmented reality presentation that illustrates the slope information of a putting green and the suggested predictive line for a given putting stroke by processing the data that are obtained by the clip-on mini-camera apparatus 16 and various sensors in it.

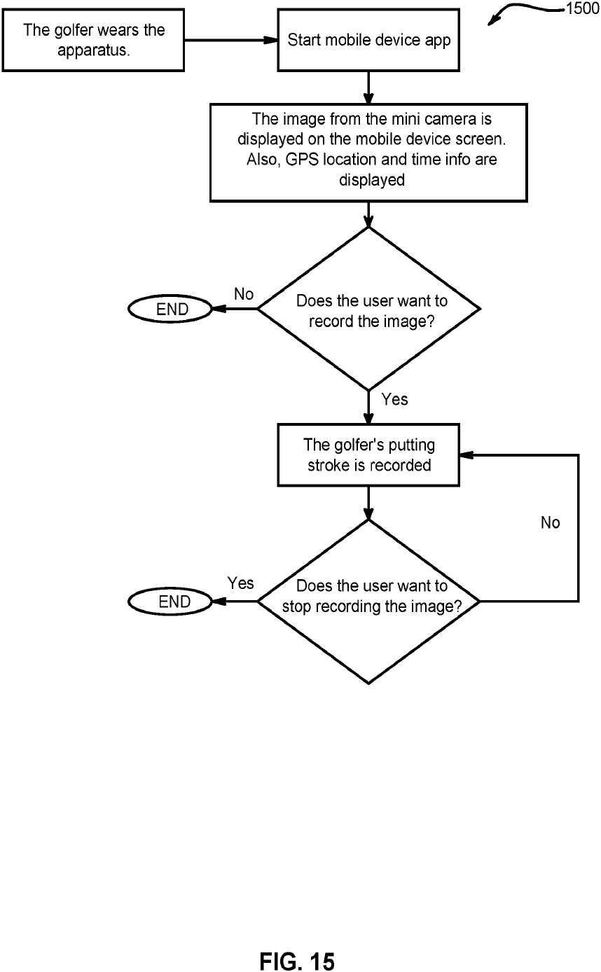

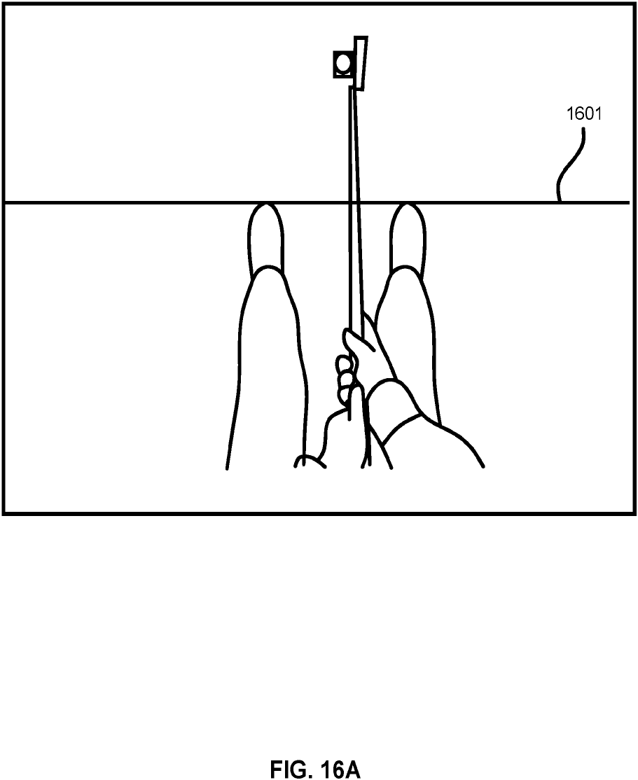

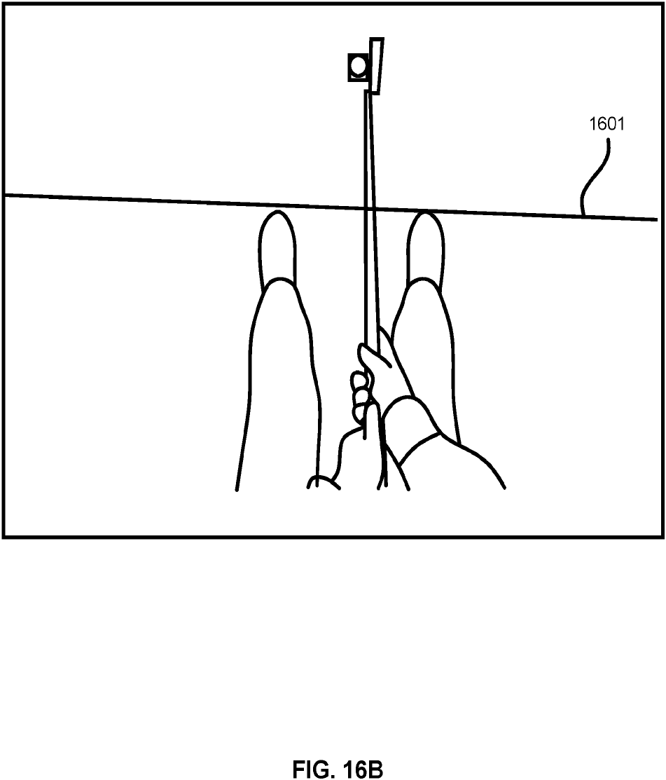

FIG. 15 illustrates one example embodiment of the basic method 1500 of a user’s interaction with the clip-on mini-camera apparatus 16. In this example embodiment, the golfer 41 and the accompanying instructor both go out for a round of golf for training purposes to obtain the information as the golfer 41 plays putting strokes. In this example embodiment, the golfer 41 clips the clip-on mini-camera apparatus 16 to the hat on the golfer’s head and adjusts the camera view in any desired perspectives such as the top-down view by using the joint 18. In an example embodiment, either the golfer or the instructor starts the mobile device app. In an example embodiment, either the golfer or the instructor turns on and off the clip-on mini-camera apparatus 16. In an example embodiment the clip-on mini-camera apparatus 16 may be turned on and off using the mobile device application interface. In an example embodiment, an image from the mini-camera is displayed on the mobile device screen. In other example embodiments, the GPS location and/or time information are also displayed.

In an example embodiment, the system determines whether or not to record the current image. In one example embodiment, the image processing algorithms recognizes the start of the putting stroke to trigger recording of the golfer’s stroke. In one example embodiment, a pre-set motion triggers recording the golfer’s putting stroke. In another example embodiment, a voice command triggers recording the golfer’s putting stroke. In another example embodiment, mobile app 105 triggers recording the golfer’s putting stroke based on a timer running in the mobile app. In another example embodiment, the push button switch 822 may be used to initiate the timer function by pressing the push button switch 822 ahead of time. In another example embodiment, a manual push button switch 822 may trigger recording the golfer’s putting stroke instead of or in combination with the mobile app 105.

In an example embodiment, the system determines when to stop recording the putting images. This determination may be made, for example by image processing algorithms, a pre-set motion, a voice activation command, a timer feature, a manual switch or push button, using GPS location information, using a mobile device app, and/or the like. With respect to the GPS location information, in an example embodiment, the start/stop recording is based on a geofence about a location such as the boundaries of each green area on a golf course.

The recorded image and collected data are then processed either on the mobile device 102 or in the application server 103 and then the analysis result is created. The analysis result may be presented in the format of data visualization such as a table and/or plot, and augmented reality display on video image frames. Thus, in an example embodiment, the system is configured to display to the golfer any images and/or data that are based on image processing and machine learning, and assist the golfer in analyzing their performance.

In an example embodiment, the system is configured to perform image processing based on the known size of an object (the calibration or reference object) captured in one or more of the images. The system is configured to identify the calibration object in the image. The system is configured to measure the size of the object (e.g., measure its diameter (the diameter of the golf ball), measure its length (e.g., the length of the putter head), etc.) In an example embodiment, the system is configured to compare the measured size of the object to a known size of the object. To do this, the system may look up the known size in a database or the known size may be preprogramed in the system. For example, the size of a golf ball may be known to be 42.67 mm in diameter. The comparison may be used to generate a scaling factor for the image, and this scaling factor may be applied to all other image processing so that all other measurements from the image(s) may be converted to actual size measurements. Based on these converted or calibrated measurements, the image processing algorithm of the system may be configured to determine relative distances and angles related to objects visible in the images. For example, the system may be configured to use image processing to determine how far the golfer’s toes are from the golf ball, the distance from the center of the golfer’s stance to the line from the golf ball, the width of the golfer’s stance, hand location relative to the body, grip location relative to the putter, and/or the like.

The mobile device 102 displays the images and collected parameters along with the analysis information on the spot (during the golf game, in real-time). Thus, in an example embodiment, the golfer is able to use the analysis information in real-time. This analysis information can be provided quickly like this based on machine learning and/or artificial intelligence analysis of the images and/or data. In another example embodiment, the golfer 41 and the instructor can review the information together and the relevant instruction is discussed. As a result, the golfer 41 can receive any additional feedback from the instructor on the spot while playing holes in a golf course and/or later after the round of golf is complete.

In addition to the analysis of the images and motion-based parameters, the specific location information obtained by the GPS in the clip-on mini-camera apparatus 16 may be linked to every single putting stroke motion at a specific area of a putting green in the golf course. The golfer 41 obtains direct feedback per each specific location of the putting green. This information can be highly valuable because a putting stroke is unique to each specific location on each putting green. The feedback per putting stroke motion can be recorded in-situ by using the audio recording function. The golf player can play the recorded audio information after the training round of golf for a reminder and repeated learning experience.

In one embodiment, the golfer 41 plays a practice round of golf by him/herself and shares the data including the images and other collected parameters with an instructor, who is remotely located, by using the mobile application interface 105. The instructor reviews the recorded images, collected data and the analytic information via their mobile device 102, and shares the feedback with the golfer 41 by using the mobile application interface 105. Therefore, the golfer 41 immediately receives the feedback from the instructor during playing a round of golf even if the golfer is not accompanied on a golf course.

Although described herein in the context of golfing and analysis of a putting stroke, this disclosure should be understood to apply as well to analyzing the swing of other golf clubs (motions with irons, utility clubs, fair woods, and drivers other than a putter), and other sport swings such as baseball batting swings, tennis racket swings, polo swings, ping pong strokes, billiards strokes, and/or the like. The activity to be analyzed may be any activity that may be recorded by an angle-adjustable wearable camera and algorithms of computer vision, machine learning, and artificial intelligence with an overhead view image of the motion or activity, to provide an analysis of the motion and/or ball movement in augmented reality display, based on image processing of the motion. Moreover, although motion is contemplated, the analysis can be based on a single image and a static stance. For example, the analysis may simply analyze the stance addressing the ball before the stroke is taken, or a snap shot at any point in the stroke. Of course, for high speed motion, the camera is configured to be a corresponding high speed, high resolution camera.

In an example embodiment, a system comprises a mobile device, such as a tablet, and codes, such as for a web app or mobile app, configured to receive imaged data, to process relative sizes, distances, angles associated with overhead images of a putting stroke, without calibration and based on the known size of a standard golf ball, and to generate augmented displays of the putting stroke.

### Example Embodiments

In an example embodiment, the mini-camera apparatus further comprises a joint that is configured to cause the mini-camera to be automatically pointed at an angle offset from vertical, for the overhead view of the putting stroke, regardless of the positioning of the hat clip.

In an example embodiment, the mini-camera apparatus further comprises a beam generator for generating a beam of light, wherein the beam of light may be visible light or infrared light, wherein the mini-camera is further configured to record a spot light generated by the beam of light.

In an example embodiment, the mini-camera apparatus further comprises a night vision module, and wherein the night vision module comprises:
a. a sensor, configured to detect light brightness,
b. a Light Emitting Diode (LED), configured to emit light in the infrared wavelength range,
wherein the night vision mode is turned on and off by the user’s manual selection, by the light detection sensor, or by a pre-programmed setting when the golfer plays at dawn, twilight, or dusk, and wherein when the night vision mode is turned on, the image is viewed and recorded in night vision mode by using infrared light.

In an example embodiment, the mini-camera apparatus further comprises a motion detection device, configured to detect a motion, configured to operate the mini-camera apparatus including turning on and off, recording the image, obtaining information from the sensors in accordance with pre-programmed motions.

In an example embodiment, the mini-camera apparatus further comprises switches, configured to manually operate the mini-camera apparatus including turning on and off, recording the image, obtaining information from the sensors, wherein the golfer manually operates the mini-camera apparatus by him/herself when another person is not available to operate.

In an example embodiment, the mini-camera apparatus further comprises at least one light source that emits a beam onto the putting area of interest by using either of the following or the combination of:
a. a laser diode or LEDs (Light Emitting Diodes) in the visible wavelength range between 400 nm and 740 nm,
b. a laser diode or LEDs (Light Emitting Diodes) for the infrared wavelength between 741 nm and 1800 nm,
wherein the user turns on and off the light source by using either of the following or the combination of:
a. a manual switch on the mini-camera apparatus,
b. the mobile device application.

In an example embodiment, the mini-camera apparatus further comprises a small base plate, configured to attach a golf accessory such as a ball marker to the top of the mini-camera apparatus through the use of one or more of magnetic materials and non-magnetic materials.

What is claimed is:

1. A mini-camera apparatus comprising:
a mini-camera for at least one of streaming and recording images, from an overhead view, of a putting stroke,
an electrical module connected to the mini-camera via a joint configured to aim the mini-camera for the overhead view of the putting stroke, wherein the joint is configured for adjusting the aim of the mini-camera view of the putting stroke.

2. The mini-camera apparatus of claim 1, further comprising an attachment mechanism, wherein the attachment mechanism is a hat clip.

3. The mini-camera apparatus of claim 1, wherein the electrical module is configured to turn on / off based on a trigger from one or more of a timer, a push button, a voice command, a GPS location, or a signal from a mobile device.

4. The mini-camera apparatus of claim 1, wherein the electrical module is configured to start/stop at least one of streaming and recording images based on a trigger from one or more of image processing algorithms, a timer, a push button, a voice command, a GPS signal, and a signal from a mobile device.

5. The mini-camera apparatus of claim 1, wherein the mini-camera apparatus is portable, for in-situ use on a golf course during a round of golf for live review or live instruction of putting techniques; and
wherein the mini-camera apparatus further comprises:
a telescopic structure, attached to a housing of the mini-camera, capable of extending a length of the telescopic structure and adjusting a position of the mini-camera;
a GPS receiver, capable of determining a location of the mini-camera apparatus,
a digital clock, capable of providing timestamp information; and
a transceiver for wirelessly sending image data to a mobile device, wherein the image data comprises images of the putting stroke.

6. A putting training system comprising:
a mini-camera apparatus comprising:
a mini-camera for at least one of streaming and recording images, from an overhead view, of a putting stroke;
an electrical module;
a joint connecting the mini-camera and the electrical module to movably aim the mini-camera for the overhead view of the putting stroke; and
an attachment mechanism connected to the electrical module, wherein the attachment mechanism is configured to attach the mini-camera apparatus to a brim of a golf hat, cap, or visor;
a mobile device; and
a server, wherein the electrical module further comprises a wireless communication module, adapted to communicate with the mobile device for transmitting the images and information; and wherein the mobile device is configured to generate statistics, analysis information, and notifications.

7. The putting training system of claim 6, wherein the mobile device is configured to display images and information in both a real-world view and an augmented reality view, operate the mini-camera apparatus, and share the information using a social media application interface and a cloud server.

8. The system of claim 6, wherein the mini-camera apparatus further comprises components and/or modules attached to and/or included in the mini-camera apparatus to provide the overhead view appropriate for covering a putting area of interest, wherein the mini-camera apparatus further comprises:
a lens or lenses to provide a wide angle of view; and/or
a zooming module, adapted to zoom in and out when viewing and recording the images, wherein the zooming module comprises: lenses and actuator(s).

9. The system of claim 6, wherein the mini-camera apparatus further comprises an image stabilization apparatus and system, adapted to compensate any blur of an image of the images(s) due to small movements of the mini-camera apparatus, wherein the image stabilization apparatus and system comprises:
a. a gyroscope,
b. actuator(s), and
c. a code for analyzing measured parameters, directing actuators to move the lenses appropriately in order to compensate for blurred images.

10. The system of claim 6, wherein the mini-camera apparatus further comprises multiple mini-camera modules, and each one of said multiple mini-camera modules is configured to capture an overhead image of the putting stroke, and wherein the system further comprises: a code for processing the images from each of the multiple mini-camera modules to improve zoom performance, achieve wide angle view, enhance images with blurred background, achieve high quality of full color, measure a distance between the mini-camera apparatus and a golf ball, and/or enhance augmented reality data.

11. The system of claim 6, wherein the mini-camera apparatus further comprises a voice recording module configured to record audio information, including dialogues of discussion between the users and instructors, and configured to play back the recorded audio information on demand.

12. The system of claim 6, wherein the mini-camera apparatus further comprises a voice recognition module and audio processing algorithms for recognizing voice commands, for operating the mini-camera apparatus including turning the mini-camera apparatus on and off.

13. The system of claim 6, wherein the mini-camera apparatus further comprises an information storage device for physically connecting to a portable storage medium to save the image data and other collected information.

14. The system of claim 6, wherein the mini-camera apparatus comprises an electrical driver, adapted to simmer on and off the mini-camera apparatus, and wherein the mini-camera apparatus operates only when it’s needed and therefore save battery power.

15. The system of claim 6, wherein the mini-camera apparatus further comprises a polarizing filter, attached to the mini-camera apparatus, configured to reduce glare and reflection and to provide improved image quality under bright sunlight and any undesirable lighting conditions.

16. The system of claim 6, wherein the mini-camera apparatus further comprises the mobile device application code for creating a three-dimension augmented reality presentation and illustrating slope information of a putting green by using data that is obtained by the mini-camera apparatus.

17. A method of providing analysis of a golf swing, the method comprising:
receiving, at a mini-camera apparatus attached to a hat, a trigger to start taking overhead images associated with the golf swing;
at least one of streaming and recording, using a mini-camera, overhead images associated with the golf swing;
transmitting, via a transceiver, the streamed/recorded images to a mobile device;
analyzing the streamed/recorded images using computer vision techniques; and
displaying, on the mobile device while on a golf course, the streamed/recorded images with augmented display information providing analysis of the golf swing based on image processing, wherein the image processing is based off of a known measurement of an object visible in the streamed/recorded images, wherein the augmented display includes the presentation of statistical data and recommendations derived by analyzing accumulated data with machine learning and artificial intelligence methods.

18. The method of claim 17, wherein a determination of one or more of distances, locations, sizes, velocity, and acceleration associated with the augmented display information are based on a known size of a golf ball visible in the streamed/recorded images.

19. The method of claim 17, wherein head-movement of a golfer during a swing motion of a club is calculated based on the relative distance between a reference stance line and a swing motion stance line.

20. The method of claim 17, wherein the mini-camera apparatus is configured to use image processing and machine learning techniques to compare changes in relative positions of one object in the image to another object in the image, over a series of images to determine the relative movement of an object of interest, wherein the image processing and machine learning are based off of a known measurement of an object visible in the streamed/recorded images.
